(19) United States
(12) Patent Application Publication
(10) Pub. No.: US 2010/0157033 A1
(43) Pub. Date: Jun. 24, 2010

(54) METHOD OF DETERMINING THE MOTION OF A POINTING DEVICE

(75) Inventor: Jan Kneissler, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,115

(22) PCT Filed: Jul. 25, 2006
(86) PCT No.: PCT/IB06/52542

§ 371 Date: Feb. 7, 2008

(30) Foreign Application Priority Data
Aug. 11, 2005 (EP) 05107395.5

(51) Int. Cl. H04N 7/18; H04N 5/228; G06K 9/00

(52) U.S. Cl. 348/61; 348/222.1; 382/107; 348/E05.001

(57) ABSTRACT

The invention describes a method of determining the motion of a pointing device (2), wherein the method comprises the steps of aiming a pointing device (2) comprising a camera (3) in the direction of a target area (A) and generating images (4) of the target area (A) aimed at by the pointing device (2) while also obtaining a sequence of relative motion vectors (V₁, V₂, V₃, V₄) pertaining to the motion of the pointing device (2), during an image frame time between images (4). The images (4) are transmitted with the corresponding relative motion vectors (V₁, V₂, V₃, V₄) to a control interface (20) where they are interpreted to determine the motion of the pointing device (2). The invention further describes a system (1) for determining the motion of a pointing device (2). Furthermore, the invention describes a control interface (20) for use in the system (1), a pointing device (2), and an electrically or electronically controllable device (10) comprising such a control interface (20).

This invention relates to a method of determining the motion of a pointing device, and to a system for determining the motion of a pointing device. The invention also relates to a control interface and a pointing device for use in such a system. Furthermore, the invention relates to a method of interleaving an image generated by a camera of a pointing device with relative motion vectors pertaining to the motion of the pointing device.

Systems which allow some level of user interaction by means of a hand-held device are becoming more and more widespread. Many home entertainment devices, for example, are supplied with a remote control hand-held device so that the user can point the remote control in the general direction of the device and press a button on the remote control to activate one of a limited number of functions for controlling the device, for example to change channels or to carry out a configuration step. Since the extent to which a remote-control type of hand-held device can be used to interact with a device is quite limited, while developments in applications for running on such systems continue to offer a wider range of possibilities, the tendency is to use a pointing device type of hand-held device to interact with the system, where such a pointing device is aimed at, for example, a display, and the movements of the pointing device are tracked in some way and interpreted to control the application running on the system.

For example, a camera incorporated in the pointing device can be used to generate images of an area in front of the pointing device, and these images are analysed to determine an object or region at which the pointing device is being aimed, as suggested in WO 2004/079707 A1. The information thus obtained can be used, for example, to change the position of a cursor in a display to “follow” the movements of the pointing device. In this way, the user can directly see the results of the movements he makes with the pointing device. The image processing, typically requiring considerable hardware effort, is generally carried out in a separate unit or module external to the pointing device.

A major problem with this type of interaction is that the image throughput of a typical communication channel from the pointing device to the external unit is limited, so that, by the time an image has been analysed, the user is actually aiming the pointing device somewhere else. As a result, the motion of the pointing device cannot always be correctly determined in time. The user becomes aware of this when the cursor appears to lag behind the movements of the pointing device, or when the cursor moves jerkily over the display. Another result of such delays arising as a result of insufficient or slow image throughput might be that an application running in the system does not react as it should to a gesture of the user made with the pointing device, if this gesture was performed too quickly for the image processing to deal with.

Therefore, an object of the present invention is to provide a way of promptly and correctly interpreting the movements of a pointing device.

To this end, the present invention provides a method of determining the motion of a pointing device, wherein the method comprises the steps of aiming a pointing device comprising a camera in the direction of a target area and generating images of the target area aimed at by the pointing device. A sequence of relative motion vectors pertaining to the motion of the pointing device is obtained during an image frame time between two images, and is transmitted with the images to a control interface where the images and the corresponding relative motion vectors are interpreted to determine the motion of the pointing device.

The term “target area” refers to the area in front of the pointing device, and, generally speaking, covers everything that falls within the field of vision of the camera of the pointing device. A user might aim the pointing device at a device with which he wishes to interact, for example at the screen of a television showing a selection of menu items, or he may aim the pointing device at any other item or object in order to issue a particular command, such as aiming at a lamp to have the lamp turned on or off. However, the user need not aim the pointing device at a particular object or device in order to issue a command, since a simple gesture made with the pointing device can also be interpreted as a command. Such a system of interaction is described in detail in WO 2004/047011 A2, which is included herewith by reference.

The images generated by the camera of the pointing device can be generated at a fixed or variable image frame rate, which might be expressed in terms of time, for example two images every second, one image every five seconds, etc. The rate at which images are generated by the camera can depend on a number of factors, such as the shutter speed, the application for which the images are being generated, the lighting conditions, the mechanics of the camera itself, etc. Not every image generated by the camera need be transmitted to the control interface. It may be sufficient, for example, to supply the control interface with every tenth image generated by the camera. Therefore, in the following, the term “image frame rate” refers to the rate at which the images intended for the control interface are generated, and the time between two such images or exposures is defined as the “image frame time”.

The relative motion vectors can be obtained at a rate other than the image frame rate, so that, for example, several relative motion vectors might be obtained during an image frame time. Here, the term “relative motion vector” is to be understood in a broad sense. Such a relative motion vector can comprise one or more values pertaining to motion sensed in one or more directions as the pointing device is being moved. Since the pointing device is also generating images as it is being moved, the relative motion vectors ultimately describe the motion of the camera, and therefore of the pointing device, relative to the images which it is generating, in terms of incremental motion “deltas”.

An appropriate system for determining the motion of a pointing device comprises a pointing device, which pointing device in turn comprises a camera for generating an image of a target area in the direction of pointing, and a motion vector determination means for determining the relative motion vectors of the pointing device. The system also comprises a control interface for interpreting the images and the relative motion vectors to determine the motion of the pointing device and a transmitter for transmitting the images and the relative motion vectors to the control interface.

An obvious advantage of the method and system according to the invention for determining the motion of a pointing device is that the continued motion of the pointing device can be tracked while an image is being processed, so that the system can react faster to the user's interaction, thereby reducing the latency of the system. In an interaction system using a pointing device to interact with a device featuring a display, for example, a cursor on the display will smoothly follow the motion of the pointing device. In an application where the pointing device is being used to aim at objects in the surroundings, the motion of the pointing device can be used to predict the gesture or motion made by the user, so that, for example, templates for object recognition can be retrieved in good time from a database, thereby keeping the overall latency of the system to a minimum. A further advantage of the method and system according to the invention is that an absolute position determined by image analysis can be used to predict and correct any inherent errors in the relative motion vectors.

The dependent claims and the subsequent description disclose particularly advantageous embodiments and features of the invention.

The image data generated by the camera of the pointing device and the relative motion vectors could be transmitted to the control interface over separate channels. However, in a preferred embodiment of the invention, the images and the relative motion vectors are transmitted via a shared channel, so that the necessary hardware is kept to a minimum. Since the image data volume is much greater than that of the relative motion vectors, which require only a fraction of the bandwidth required by the images, the images and the relative motion vectors are preferably interleaved for transmission over a single channel. To this end, the image data corresponding to an image is divided into smaller chunks or segments, i.e. the image is segmented. The individual image segments can then be transmitted to the control interface in a certain order, and information pertaining to the relative motion vectors can be sandwiched between the image segments. This technique of alternately sending image data and relative motion vector data is termed “interleaving” in the following.

A method of interleaving an image generated by a camera of a pointing device with relative motion vectors pertaining to the motion of the pointing device and associated with the image comprises, according to the invention, splitting the image into a number of image segments prior to transmission to a control interface, and succeeding or preceding each image segment in transmission by a relative motion vector to give an interleaved data stream.

A pointing device according to the invention comprises, in addition to the camera already mentioned above, one or more motion vector determination means for determining relative motion vectors of the pointing device. The relative motion vector of the pointing device can comprise one or more elements, such as a translation and one or more rotations about the axes of a coordinate system in three-dimensional space. Therefore, the motion vector determination means can comprise acceleration, gyroscopic, or magnetic sensors, or a combination of these. Equally, it is also conceivable that the relative motion vectors will be deduced from an image analysis of the images generated by the camera of the pointing device, so that, in such a case, the motion vector determination means comprise suitable image processing algorithms. Such an algorithm might be based, for example, on a technique of locating and tracking matching points in successive images, or might make use of known techniques for detecting arbitrary shapes in an image, such as the Hough transformation. The pointing device might comprise a suitable motion vector compilation unit for assembling individual motion parameters into a complete relative motion vector. For example, information describing a translation of the pointing device can be obtained by one or two motion sensors or by suitable image analysis. Further information describing the angle by which the pointing device is tilted forwards or backwards can be obtained from a further motion sensor. These information elements can be put together to compose a relative motion vector describing the translation and rotation. The techniques and algorithms mentioned briefly here will be known to a person skilled in the art and therefore must not be explained in more detail.

To prepare the image data and the relative motion vector data for transmission to the control interface, the pointing device according to the present invention preferably also comprises a segmentation unit for segmenting the images prior to transmission, and an interleaving unit for including relative motion vectors between the image segments. The resulting interleaved data stream can be buffered prior to transmission or can be transmitted immediately to the control interface.

As already mentioned, the relative motion vectors can be obtained at a faster rate than the image frame rate, so that the control interface can be continually supplied with updated motion information describing the movement of the pointing device since generation of the previous image. Analysis of the images generated by the camera is carried out to determine the point at which the user is aiming the pointing device. Generally, the target point is simply the point in the centre of the image, and usually coincides with the virtual intersection of the axis of pointing with the plane of the image. When the user is aiming the pointing device at an object in order to select an option or issue a command, computer vision algorithms can be applied to determine the target point in the target area image with a view to identifying the object or option.

A method of processing the image data of the target area image using computer vision algorithms might comprise detecting distinctive points in the target area image, determining corresponding points in a template, e.g. a template of a display, a device, or the surroundings, and developing a transformation for mapping the points in the target area image to the corresponding points in the template. This transformation can then be used, for example, to determine the point in the template at which the user is aiming the pointing device, and which can be used to easily identify the option which has been targeted by the user. Comparing the image data with the pre-defined template may thereby be restricted to identifying and comparing only salient points such as distinctive corner points. The term “comparing”, as applicable in this invention, is to be understood in a broad sense, i.e. by only comparing sufficient features in order to quickly identify the option at which the user is aiming.

After an image has been generated by the camera of the pointing device, however, the user may continue to move the pointing device, for example across the display of a television in order to pursue his intention of choosing a particular menu option or to carry on making a certain gesture associated with a command. Therefore, the target point identified in an image most likely no longer corresponds to the actual point aimed at by the user by the time the image analysis has completed for that image.

According to the invention, however, the fact that the control interface can essentially continuously receive “newer” information pertaining to the motion of the pointing device while it is still busy with processing the “older” image data allows the control interface to track the motion of the pointing device, using the motion deltas given by the relative motion vectors, in order to estimate or predict the actual point at which the user is aiming the pointing device by the time the image analysis has finished analysing the image assembled from the image segments. Using the estimated or predicted information, the system can, for example, correctly place the cursor in the display to reflect the actual point aimed at by the pointing device, or can make an educated guess at the templates which will next be required.

Segmenting the images in the manner described above and sending them to the control interface with continually updated relative motion vector allows the system to correctly react to the movement of the pointing device. However, some applications might require a faster reaction time, while others might be satisfied with a slower reaction time. An example of an application requiring a fast reaction time might be a gaming application, where the user must react quickly to certain situations, and will move the pointing device quickly as a result. A “slow” application might be one where the user simply aims the pointing device at a display to choose one of a number of options presented in a menu, but where speed is not an issue, so that the user can move the pointing device in a relatively sedate manner. The time taken for the system according to the invention to react to movements of the pointing device depends to a large extent on the rate at which images and relative motion vectors are transmitted to the control interface.

Therefore, in a preferred embodiment of the invention, the number of image segments into which an image is split before interleaving with the relative motion vectors can advantageously be chosen according to the motion of the pointing device. Thus, if the pointing device is being moved slowly, it may be sufficient to split the image into a relatively small number of segments, say three, and interleaving these three segments with relative motion vectors before transmission. On the other hand, if the user is moving the pointing device quite quickly, it might be more prudent to supply a greater number of relative motion vectors in order to have sufficient information to correctly track the motion of the pointing device. Therefore, in such a case, the image might be split into a greater number of segments, say ten, and the image segments might then be interleaved with ten relative motion vectors before transmission to the control interface. The large number of relative motion vectors for a single image gives the system enough information to estimate the actual point at which the pointing device is being aimed by the time the image has been processed. The system according to the invention therefore preferably comprises an adjustment unit for determining, on the basis of the image analysis and relative motion vector analysis, any adjustments to be made to the image frame rate of the camera of the pointing device and/or the number of image segments. Such adjustments can be transmitted to the pointing device by means of a suitable communication interface.

In a further embodiment of the invention, the image frame rate could also be adjusted according to the motion of pointing device, for example to supply images at a faster or slower rate, as required. Thus, for an application requiring a speedy response, the pointing device might be instructed to transmit every second image along with relative motion vectors. On the other hand, an application which is satisfied with a slower response time can instruct the pointing device to send images at a slower rate. It is even conceivable that control signals generated by the control interface can be used to influence the shutter speed of the camera, thereby allowing images to be generated at a desired rate.

The control interface to which the interleaved data stream is sent comprises a receiver for receiving an interleaved data stream from a pointing device, and an extractor unit for extracting the image segments and the relative motion vectors from the interleaved data stream. To retrieve the original image data, the control interface comprises a recombining unit for recombining the image segments to obtain a corresponding entire image, which can then be analysed in an image analysis unit to determine position information pertaining to a target point at which the pointing device is being aimed, and a relative motion analysis unit for analysing the relative motion vectors to determine absolute position information pertaining to the target point. In this way, the control interface can predict the motion of the pointing device so that it can, for example, supply an application with the necessary information for correctly presenting a cursor on screen corresponding to the actual point at which the pointing device is being aimed, or it can use the information to retrieve suitable templates in good time from a database in order to speed up the image analysis process when identifying objects at which the pointing device is being aimed.

The control interface can be a stand-alone unit, or can be incorporated in any suitable device, for example in a computer or home entertainment device with which a user can interact by means of a pointing device in the manner described above. The device can be any electrically or electronically controllable device, and can be equipped with the control interface at time of manufacture, or can be upgraded with the necessary modules and interfaces at a later point in time.

Other objects and features of the present invention will become apparent from the following detailed descriptions considered in conjunction with the accompanying drawing. It is to be understood, however, that the drawings are designed solely for the purposes of illustration and not as a definition of the limits of the invention.

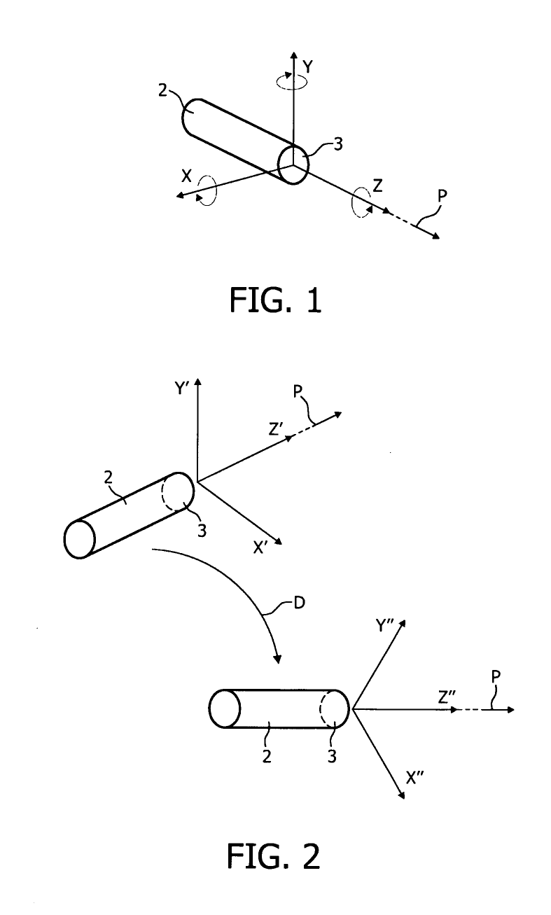

FIG. 1 shows the coordinate system of a pointing device pursuant to the invention;

FIG. 2 shows a path followed by a pointing device pursuant to the invention;

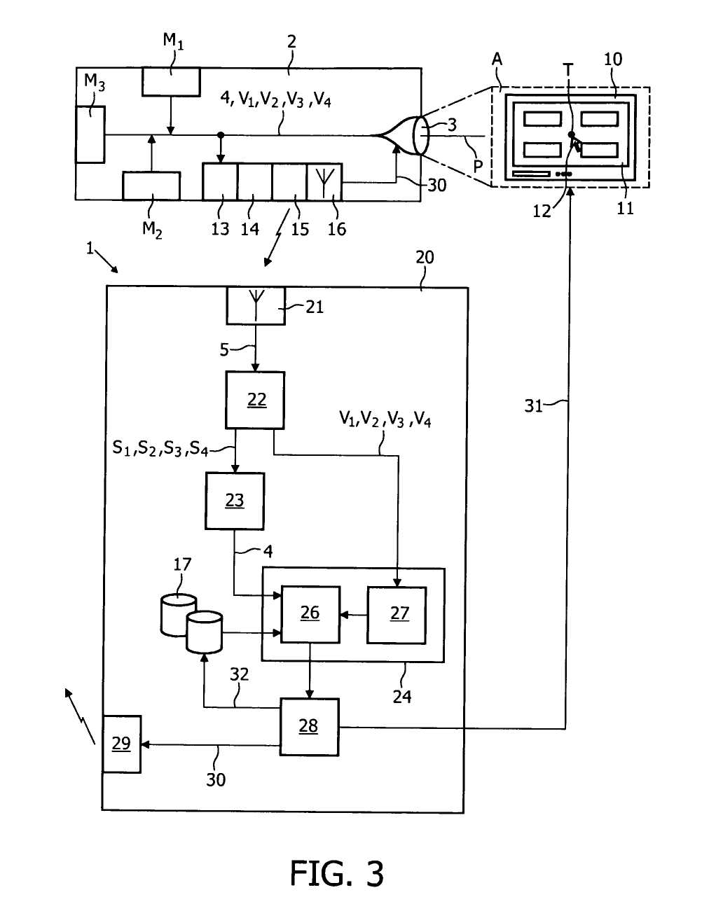

FIG. 3 shows a system for determining the motion of a pointing device according to an embodiment of the invention;

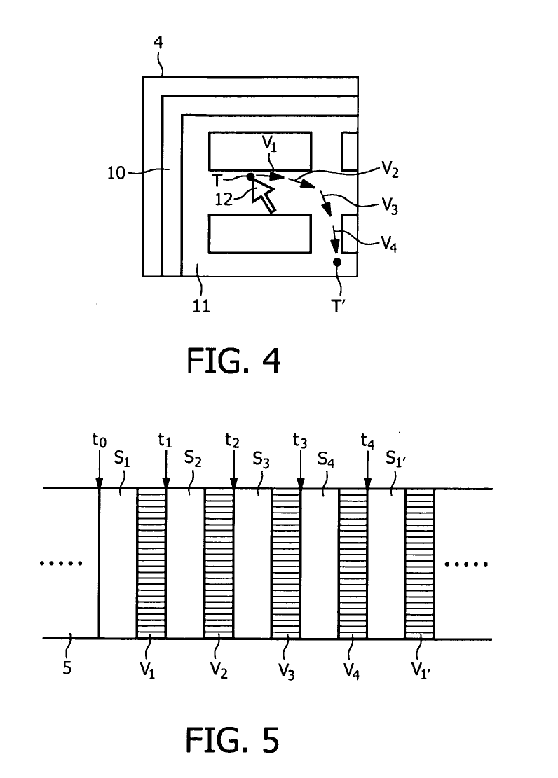

FIG. 4 is a schematic representation of a target area image generated by a camera of a pointing device according to an embodiment of the invention;

FIG. 5 is a schematic representation of an interleaved data stream pursuant to the invention.

In the drawings, like numbers refer to like objects throughout. FIG. 1 shows a pointing device 2 with a camera 3 incorporated in its tip, so that the camera 3 can generate images of a target area in front of the pointing device 2 and in the direction of pointing P. The pointing device 2 is assigned a coordinate system in three-dimensional space, shown by the axes X, Y and Z, which can be arbitrarily attributed. Here, the X axis is defined as a horizontal axis perpendicular to the longitudinal axis of the pointing device 2, the Y axis extends in a vertical direction, while the Z axis corresponds to the longitudinal axis of the pointing device 2. The pointing device 2 is free to move in any of the three directions given by these axes X, Y, Z, i.e. left and right, forwards and back, up and down, in any combination. Furthermore, the pointing device 2 can be rotated about one or more of the axes X, Y, Z. A rotation about the Y axis is generally known as “yaw”, a rotation about the X axis is generally known as. “pitch” or “tilt”, and a rotation about the longitudinal Z axis is generally known as “roll”. When the pointing device 2 is moved by the user (not shown in the diagram) from a first position to a second position, the resulting change in position can be described by a motion vector, which, depending on the second position, can comprise one or more, perhaps even all, of the components of motion of the six possible degrees of freedom described above.

FIG. 2 shows the pointing device 2 at a first position, given by the axes X′, Y′, Z′ of the coordinate system, and at a second position, given by the axes X″, Y″, Z″, after being moved by the user in a direction of motion shown by the arc D. Between moving the pointing device 2 from its first position to its second position, the user can also rotate the pointing device 2, so that the angles of pitch, roll, and yaw may also be taken into consideration.

To determine the relative motion of the pointing device 2, the pointing device 2 is equipped with a number of motion vector detecting means M₁, M₂, M₃, as illustrated in FIG. 3, which shows the pointing device 2 in the context of a system 1 for determining the relative motion of the pointing device 2. Image and motion information collected by the pointing device 2 is transmitted to a control interface 20 for interpretation. The control interface 20 can control a device 10 according to actions taken by a user with the pointing device 2. In this example, the device to be controlled 10 is a television 10 with a display 11, showing a graphical user interface over which the user can move a cursor 12 to choose one of a selection of options presented in the display 11.

The motion vector detecting means M₁, M₂, M₃ of the pointing device 2 can be arranged in or on the pointing device 2, as appropriate, to detect motion in the directions in which the pointing device 2 is moved. The various components of the pointing device's motion translations in the direction of one or more of the axes X, Y, Z and/or one or more rotations about the axes X, Y, Z are compiled to give a relative motion vector V₁, V₂, V₃, V₄. The various motion detecting means M₁, M₂, M₃ can generate measurements continuously, so that relative motion vectors V₁, V₂, V₃, V₄ can be produced more or less continuously, or at predefined regular intervals, so that relative motion vectors V₁, V₂, V₃, V₄ are also compiled at regular intervals.

The pointing device 2 is being aimed at a device 10, which shows a graphical user interface of an application in a display 11. To interact with the application, the user can aim the pointing device 2 at the display 11, so that the camera 3 of the pointing device 2 generates an image 4 of a target area A in the direction of pointing P, encompassing some or all of the display 11. Images 4 are generated by the camera 3 of the pointing device 2 at intervals given by the shutter speed and possibly also lighting conditions in which the pointing device 2 is being operated.

FIG. 4 shows a portion of the display 11 captured in an image 4 of the television 10. The user is aiming the pointing device 2 at the display 11 to choose one of a number of menu options. A cursor 12 appears at the target point T to show the user the point in the display 11 at which he is aiming the pointing device 2. The image 4 was generated at some point in time while the user was moving the pointing device 2 over the display 11. However, by the time this image 4 has been processed, as will be described later, the pointing device 2 will have been moved on, so that the target point T at which the pointing device 2 is actually being aimed is no longer the “old” target point T of the image 4. Within the image frame time, i.e. the time between two images 4, the motion detecting means M₁, M₂, M₃ generate relative motion vectors V₁, V₂, V₃, V₄ giving an approximation of the motion of the pointing device 2 relative to the target area A from the first target point T to a second target point T.

The new target point T can be estimated on the basis of the image 4 and the deltas given by the relative motion vectors V₁, V₂, V₃, V₄. To transmit the image 4 and the relative motion vectors V₁, V₂, V₃, V₄ to the control interface 20 in such a way that the relative motion vectors V₁, V₂, V₃, V₄ can be availed of without having to wait for the entire image to arrive, the image 4 is split into a number of segments S₁, S₂, S₃, S₄ and interleaved with the relative motion vectors V₁, V₂, V₃, V₄ as shown in FIG. 5. Here, the image 4 is split into four segments S₁, S₂, S₃, S₄, and the four relative motion vectors V₁, V₂, V₃, V₄ are sandwiched between the segments S₁, S₂, S₃, S₄ to give an interleaved data stream 5.

The time t₀ is taken to be the time at which the first segment S₁ of the image 4 is transmitted. The four segments of the image 4 are transmitted at intervals given by the times t₁, t₂, and t₃, respectively. A relative motion vector follows each image segment, so that relative motion vector V₁ follows image segment S₁, relative motion vector V₂ follows image segment S₂, and so on. After the fourth image segment S₄ and the fourth relative motion vector V₄ have been transmitted in this interleaved manner, the process is repeated at t₄, commencing with the first image segment S′₁ of the next image and the first relative motion vector V′₁ associated with that image.

Analysis of the image segments S₁, S₂, S₃, S₄ and the relative motion vectors V₁, V₂, V₃, V₄ then proceeds as follows: once a full image has been received, an absolute position, i.e. the target point at which the user was aiming the pointing device at the instant in which the image was captured, can be determined. In this example, let us assume that a value for the previous target point, given by a variable “last_absolute_position”, has been determined for a previous time, say t₁, which is stored in the variable “last_absolute_time”. Then, once all the image segments S₁, S₂, S₃, S₄ have been received for the current image 4, it is possible to determine the point at which the user was aiming the pointing device at the instant the image 4 was captured, i.e. at time t₀. This position is corrected with the deltas given by the relative motion vectors V₁, V₂, V₃, V₄, to yield a value for “actual_postion”, giving an approximation or estimation of the actual point at which the user is aiming the pointing device by the time the image processing of the image 4 has completed, i.e. at time t₃. The variable “last_absolute_position” is then updated with the corrected value given by “actual_position”, and the variable “last_absolute_time” is adapted accordingly to the value of t₃. These variables can then be used as input to further methods for smoothing and/or predicting motion on a finer-grained level.

Note that the relative motion vectors V₁, V₂, V₃, V₄ need not have been compiled directly prior to being transmitted, but that they can have been generated and compiled beforehand. They may be generated at a faster rate than those actually being transmitted, so that the most current relative motion vector is transmitted while the others are discarded. Also, the relative motion vectors V₁, V₂, V₃, V₄ need not be generated at precisely regular intervals, particularly when they are being generated on the basis of image analysis, so that the actual intervals between generation of the relative motion vectors can vary, or can be regular. Similarly, the segments into which an image is divided need not necessarily all be of equal size, but can vary in size if necessary.

Returning to FIG. 3, the image 4 is spilt into segments S₁, S₂, S₃, S₄ in a segmentation unit 13 and interleaved with the relative motion vectors V₁, V₂, V₃, V₄ in an interleaving unit 14 of the pointing device 2 before being transmitted by a transmitter 15 to the control interface 20.

The control interface receives the interleaved data stream 5 by means of a receiver 21. It can then extract the image and motion information from the interleaved data stream 5 in an extractor unit 22, the outputs of which are the image segments S₁, S₂, S₃, S₄ and the relative motion vectors V₁, V₂, V₃, V₄, which are forwarded to an image recombining unit 23 and a relative motion analysis unit 27, respectively. The image recombining unit 23 recombines the image segments S₁, S₂, S₃, S₄ to restore the original image 4. The image is then passed to an image analysis unit 26, where it is analysed to determine the point at which the user is aiming the pointing device 2. This procedure is described in detail in WO 2004/047011 A2.

Meanwhile, in the relative motion analysis unit 27, the path followed by the pointing device 2 is at least partially reconstructed from the information supplied by the relative motion vectors V₁, V₂, V₃, V₄. A partial reconstruction may suffice, since it may not be relevant, for example, if the pointing device is being moved forward in the direction of pointing, or if the pointing device 2 is being rotated about its own longitudinal axis. The virtual path across the image 4 originating at the first target point T and reconstructed using the deltas given by the relative motion vectors V₁, V₂, V₃, Vₐ, yields an approximation to the actual target point T′ at which the user is aiming the pointing device 2 by the time the image analysis unit has obtained the image 4 associated with the first target point T.

This information can be used then to optimise the image analysis with a view to controlling the device 10, an application running on the device 10, or the pointing device 2. An adjustment unit 28 receives information relevant to the image 4, the relative motion vectors V₁, V₂, V₃, V₄, and/or the actual target point T′, and generates appropriate control signals 30, 31. For example, the information obtained about the actual point T′ at which the user is aiming the pointing device 2 can be used to issue a suitable command 32 causing correct templates to be retrieved from a memory 17 in good time, thereby speeding up the image analysis and reducing the system latency. The adjustment unit 28 can also inform the application running on the device 10 of the actual target point, by means of a suitable signal 31, of the actual target point T′ of the pointing device 2 so that the cursor 12 is updated in good time to correctly follow the motion of the pointing device 2 over the display 11.

Another function of the adjustment unit 28 can be to issue appropriate commands to the pointing device 2 to influence the image frame rate and/or the number of segments S₁, S₂, S₃, S₄ into which an image 4 is to be split, by means of a suitable control signal 30 transmitted to the pointing device 2 by means of a transmitter 29. The pointing device 2, equipped with a receiver 16, can receive the commands 30 issued by the adjustment unit 28 and can react accordingly. In this way, the system can react to a rapid movement of the pointing device 2 by, for example, having the image 4 split into a greater number of segments, thereby allowing the pointing device 2 to supply a correspondingly greater number of relative motion vectors in the interleaved data stream 5, so that the system can ultimately track the motion of the pointing device 2 with a greater degree of accuracy.

Although the present invention has been disclosed in the form of preferred embodiments and variations thereon, it will be understood that numerous additional modifications and variations could be made thereto without departing from the scope of the invention. For example, it may not be necessary to detect movement in all possible degrees of freedom of the pointing device, so that the pointing device can be realised with only the required motion detecting means for the desired degrees of freedom.

For the sake of clarity, it is also to be understood that the use of “a” or “an” throughout this application does not exclude a plurality, and “comprising” does not exclude other steps or elements. A “unit” or “module” may comprise a number of blocks or devices, unless explicitly described as a single entity.

1. A method of determining the motion of a pointing device (2), wherein the method comprises the steps of
aiming a pointing device (2) comprising a camera (3) in the direction of a target area (A);
generating images (4) of the target area (A) aimed at by the pointing device (2);
obtaining a sequence of relative motion vectors (V₁, V₂, V₃, V₄) pertaining to the motion of the pointing device (2), during an image frame time between two images (4);
transmitting the images (4) with the corresponding relative motion vectors (V₁, V₂, V₃, V₄) to a control interface (20);
interpreting the images (4) and the corresponding relative motion vectors (V₁, V₂, V₃, V₄) to determine the motion of the pointing device (2).

2. A method according to claim 1, wherein an image (4) is segmented to give a number of image segments (S₁, S₂, S₃, S₄), and the relative motion vectors (V₁, V₂, V₃, V₄) of the corresponding image frame time are interleaved with the image segments (S₁, S₂, S₃, S₄), prior to transmission, to give an interleaved data stream (5) for transmission to the control interface (20).

3. A method according to claim 1 or claim 2, wherein an image frame rate for generating images (4) of the target area (A) and/or the number of segments (S₁, S₂, S₃, S₄) into which an image is segmented are adjusted according to the motion of the pointing device (2).

4. A method according to any of the preceding claims, wherein a relative motion vector (V₁, V₂, V₃, V₄) comprises information pertaining to spatial coordinates of the pointing device (2) and/or a translation of the pointing device (2) and/or a rotation of the pointing device (2).

5. A method of interleaving an image (4), generated by a camera (3) of a pointing device (2), with relative motion vectors (V₁, V₂, V₃, V₄) pertaining to the motion of the pointing device (2) and associated with the image (4), wherein the image (4) is split into a number of image segments (S₁, S₂, S₃) and an image segment (S₁, S₂, S₃) is succeeded or preceded by a relative motion vector (V₁, V₂, V₃, V₄) to give an interleaved data stream (5).

6. A system (1) for determining the motion of a pointing device (2), comprising
a pointing device (2), which pointing device (2) comprises a camera (3) for generating an image (4) of a target area (A) in the direction of pointing (P);
a motion vector determination means (M₁, M₂, M₃) for determining the relative motion vectors (V₁, V₂, V₃, V₄) of the pointing device (2);
a control interface (20) for interpreting the images (4) and the relative motion vectors (V₁, V₂, V₃, V₄) to determine the motion of the pointing device (2);
a transmitter (25) for transmitting the images (4) and the relative motion vectors (V₁, V₂, V₃, V₄) to the control interface (20).

7. A system (1) according to claim 6, comprising an adjustment unit (28) for determining adjustments to be made to the image frame rate of the camera (3) of the pointing device (2) and/or the number of image segments (S₁, S₂, S₃).

8. A control interface (20) comprising:
a receiver (21) for receiving images (4) and relative motion vectors (V₁, V₂, V₃, V₄) in an interleaved data stream (5) from a pointing device (2);
an extractor unit (22) for extracting relative motion vectors (V₁, V₂, V₃, V₄) and image segments (S₁, S₂, S₃, S₄) from the interleaved data stream (5);
a recombining unit (23) for recombining the image segments (S₁, S₂, S₃, S₄) to obtain a corresponding entire image (4);
an image analysis unit (26) for analysing the image (4) to determine position information pertaining to a target point (T) in the image (4);
a relative motion analysis unit (27) for analysing the relative motion vectors (V₁, V₂, V₃, V₄) to determine absolute position information pertaining to the target point (T).

9. A pointing device (2) comprising:
a camera (3) for generating images (4) of a target area (A) in front of the pointing device (2) in the direction of pointing (P).
motion vector determination means (M₁, M₂, M₃) for determining relative motion vectors (V₁, V₂, V₃, V₄) of the pointing device (2);
a segmentation unit (13) for segmenting the image (4) into a number of image segments (S₁, S₂, S₃, S₄);
an interleaving unit (14) for interleaving the relative motion vectors (V₁) V₂, V₃, V₄) with the image segments (S₁, S₂, S₃, S₄) in an interleaved data stream (5);
a transmitter (25) for transmitting the interleaved data stream (5) to the control interface (20).

10. An electrically or electronically controllable device (10) comprising a control interface (20) according to claim 8.
